(19) United States
(12) Patent Application Publication
(10) Pub. No.: US 2023/0006487 A1
(43) Pub. Date: Jan. 5, 2023

(54) THREE-SUSPENSION POLE MAGNETIC SUSPENSION SHEET SWITCHED RELUCTANCE MOTOR

(71) Applicant: HUAIYIN INSTITUTE OF TECHNOLOGY, Huaian City (CN)

(72) Inventors: Tao ZHANG, Huaian City (CN); Qianyun LE, Huaian City (CN); Zixin WANG, Huaian City (CN); Peng BAO, Huaian City (CN); Jie CHEN, Huaian City (CN); Honghai LI, Huaian City (CN); Zujun DING, Huaian City (CN); Xiaoting YE, Huaian City (CN); Shasha WU, Huaian City (CN); Bin LIU, Huaian City (CN); Weihong DING, Huaian City (CN)

(21) Appl. No.: 17/781,800

(22) PCT Filed: Sep. 1, 2021
(86) PCT No.: PCT/CN2021/116038

§ 371 Date: Jun. 2, 2022

(30) Foreign Application Priority Data
Sep. 17, 2020 (CN) 202010981189.2

(51) Int. Cl. H02K 1/24; H02N 15/00; H02K 1/14

(52) U.S. Cl. CPC H02K 1/246; H02N 15/00; H02K 1/148; H02K 19/103

(57) ABSTRACT

A three-suspension pole magnetic suspension sheet switched reluctance motor includes a stator and a rotor. The stator includes a motor stator iron core, a magnetic conductive bridge, and a permanent magnet ring. Three stator suspension teeth and three stator torque teeth are distributed at intervals on an inner periphery of the motor stator iron core. The stator torque teeth are respectively connected to the motor stator iron core. The stator torque teeth are axially distributed and have inverted U-shapes. The magnetic conductive bridge is connected to the motor stator iron core through the permanent magnet ring. The magnetic conductive bridge includes a magnetism collection ring protruding inwards into the rotor. Rotor teeth are distributed on an outer side of the rotor. An outer air gap is between the rotor tooth and the motor stator iron core. An inner air gap is between the rotor tooth and the magnetism collection ring.

### TECHNICAL FIELD

The present invention relates to the technical field of magnetic suspension sheet switched reluctance motors, and in particular, to a three-suspension pole magnetic suspension sheet switched reluctance motor.

### BACKGROUND

There are no permanent magnets and windings on a rotor of a magnetic suspension switched reluctance motor, which has the advantages of no friction and wear, simple structure, firmness, and high strength, is easy to operate at high speed, and has a great application prospect in the field of high-speed applications.

In order to realize the stable suspension operation of the rotor of the magnetic suspension switched reluctance motor, it is necessary to constitute a five-degree-of-freedom magnetic suspension switched reluctance motor system by a two-degree-of-freedom magnetic suspension switched reluctance motor, a radial two-degree-of-freedom magnetic bearing, an axial single-degree-of-freedom magnetic bearing, or a radial-axial three-degree-of-freedom magnetic suspension bearing, which leads to a long axial length of the system, low critical rotating speed, low suspension force density and power density, strong coupling between the suspension force and torque, complex control, and difficult to be industrially applied in the field of miniaturized liquid transfer. Each tooth of the traditional bearingless switched reluctance motor is provided with two windings. The magnetic fields generated by the two windings together act to generate the suspension force and torque, which leads to strong coupling between a suspension magnetic field and a torque magnetic field, and complex control. Moreover, there is no permanent magnet on the traditional bearingless switched reluctance motor, which cannot be designed to be sheet-shaped. Therefore, the application thereof in the fields of liquid transfer such as sealing pumps is also limited. Chinese invention patent (CN102306995A) relates to a permanent magnet biased bearingless switched reluctance motor, in which 12 stator poles and 14 rotor poles are arranged. A stator is provided with four suspension poles and eight torque poles, and the number of rotor teeth is 14, which realizes the natural decoupling between torque and a suspension force. However, the magnetic suspension switched reluctance motor of this structure requires two switching power amplifiers to realize the two-degree-of-freedom stable suspension of the rotor. Moreover, the number of radial circumferential poles is large and the pole area is small, resulting in small suspension force. It is difficult to reflect the excellent performance of the magnetic suspension switched reluctance motor.

### SUMMARY

Purpose of invention: in order to solve the problem in the prior art, the present invention provides a three-suspension pole magnetic suspension sheet switched reluctance motor, in which a stator and a rotor of the motor are designed to be sheet-shaped, and the passive axial suspension is realized using a magnetic resistance. Only one three-phase inverter is required to control the radial two-degree-of-freedom stable suspension of the rotor. The radial utilization rate is high, and the suspension force density and the torque density are higher.

Technical solution: the present invention provides a three-suspension pole magnetic suspension sheet switched reluctance motor, including a stator and a rotor located in the rotor, where the stator includes a motor stator iron core, a magnetic conductive bridge, and a permanent magnet ring; a stator suspension tooth A, a stator suspension tooth B, a stator suspension tooth C, a stator torque tooth X, a stator torque tooth Y, and a stator torque tooth Z are distributed at intervals on an inner periphery of the motor stator iron core; the three stator suspension teeth and the three stator torque teeth are arranged at intervals; the stator torque tooth X, the stator torque tooth Y, and the stator torque tooth Z are respectively connected to the motor stator iron core through a magnetism isolation aluminum block; three-phase symmetric suspension windings are wound on the three stator suspension teeth, and are in star-shaped connection; the three stator torque teeth are axially distributed and are of inverted U-shaped structures; U-shaped opening ends of the three stator torque teeth face the rotor; torque windings reversely connected in series are wound on each inverted U-shaped stator torque tooth; both ends of the magnetic conductive bridge are connected to the motor stator iron core through the permanent magnet ring; the middle portion of the magnetic conductive bridge is provided with a magnetism collection ring which protrudes inwards and extends into the rotor; six rotor teeth are uniformly distributed on an outer side of the rotor, i.e., a rotor tooth R₁ to a rotor tooth R₆; and an outer air gap is formed between the rotor tooth and the motor stator iron core, and an inner air gap is formed between the rotor tooth and the magnetism collection ring.

Furthermore, an angle of 120° is formed among the three stator suspension teeth, and an axis of the stator suspension tooth A overlaps a +x-axis.

Furthermore, a radian of the three stator suspension teeth is equal to 60°; a radian of the rotor tooth R₁ to the rotor tooth R₆ is equal to 30°; the stator torque tooth X, the stator torque tooth Y, and the stator torque tooth Z are asymmetrically distributed; and a radian of each stator torque tooth is equal to 30°.

Furthermore, an axis of the stator torque tooth X is located at 60° counterclockwise from the +x-axis, an axis of the stator torque tooth Y is located at 200° counterclockwise from the +x-axis, and an axis of the stator torque tooth Z is located at 280° counterclockwise from the +x-axis.

Furthermore, when the stator suspension tooth A, the stator suspension tooth B, and the stator suspension tooth C are respectively aligned with the axes of the rotor tooth R₆, the rotor tooth R₂, and the rotor tooth R₄, the stator torque tooth X is aligned with the rotor tooth R₁, the radian of the stator torque tooth Y before the rotor tooth R₃ in the counterclockwise direction is 20°, and the radian of the stator torque tooth Z behind the rotor tooth R₅ in the counterclockwise direction is 20°.

Furthermore, the magnetism collection ring, the rotor, and the motor stator iron core are designed to be sheet-shaped.

Furthermore, the motor stator iron core and the rotor are formed by laminating silicon steel steels, and the magnetism collection ring and the magnetic conductive bridge are made of a whole magnetic conductive material.

### Beneficial Effects

According to the three-suspension pole magnetic suspension sheet switched reluctance motor provided by the present invention, by requiring only one three-phase inverter, the two-degree-of-freedom stable suspension of a rotor can be realized, a torque magnetic flux path is separated from a suspension magnetic flux path, and the torque and a suspension force are naturally decoupled. The magnetic suspension sheet switched reluctance motor has the advantages of large suspension force density, low manufacturing cost and power consumption, being easy to control, etc.

According to the present invention, a stator and a rotor of the motor are designed to be sheet-shaped, and the passive axial suspension is realized using a magnetic resistance. The stable suspension and rotation of the rotor can be realized by only controlling a radial two-degree-of-freedom. The axial utilization rate is high.

### BRIEF DESCRIPTION OF THE DRAWINGS

FIG. 1 is an axial cross-sectional view of a three-suspension pole magnetic suspension sheet switched reluctance motor, and a diagram of a torque magnetic flux according to the present invention.

FIG. 2 is a cross-sectional view of suspension teeth of a three-suspension pole magnetic suspension sheet switched reluctance motor, and a diagram of a suspension magnetic circuit according to the present invention.

FIG. 3 is a top view of a three-suspension pole magnetic suspension sheet switched reluctance motor according to the present invention.

FIG. 4 is a diagram of a radial suspension magnetic flux of a three-suspension pole magnetic suspension sheet switched reluctance motor according to the present invention.

FIG. 5 is a diagram of the power-on position of a winding on a torque tooth X of a three-suspension pole magnetic suspension sheet switched reluctance motor according to the present invention.

FIG. 6 is a diagram of the power-on position of a winding on a torque tooth Y of a three-suspension pole magnetic suspension sheet switched reluctance motor according to the present invention.

FIG. 7 is a diagram of the power-on position of a winding on a torque tooth Z of a three-suspension pole magnetic suspension sheet switched reluctance motor according to the present invention.

1-magnetic conductive bridge, 2-permanent magnet ring, 3-motor stator iron core, 4-magnetism isolation aluminum block, 5-stator torque tooth, 6-torque winding, 7-suspension winding, 8-outer air gap, 9-rotor, 10-inner air gap, 11-magnetism collection ring, 12-static bias magnetic flux, 13-suspension control magnetic flux, 14-torque magnetic flux.

### DETAILED DESCRIPTION

The present invention is further described below in combination with the accompanying drawings. The following embodiments are merely used for more clearly describing the technical solutions of the present invention, and are not intended to limit the scope of protection of the present invention.

As shown in FIGS. 1 to 3, embodiments of the present invention disclose a three-suspension pole magnetic suspension sheet switched reluctance motor, including a stator and a rotor 9 located in the rotor. The stator includes a motor stator iron core 3, a magnetic conductive bridge 1, and a permanent magnet ring 2. Three stator suspension teeth and three stator torque teeth 5 are distributed at intervals on an inner periphery of the motor stator iron core 3. In order to facilitate the illustration, the three stator suspension teeth and the three stator torque teeth are respectively marked as a stator suspension tooth A, a stator suspension tooth B, a stator suspension tooth C, a stator torque tooth X, a stator torque tooth Y, and a stator torque tooth Z. The three stator suspension teeth and the three stator torque teeth are arranged at intervals. The stator torque tooth X, the stator torque tooth Y, and the stator torque tooth Z are respectively connected to the motor stator iron core 3 through a magnetism isolation aluminum block 4.

Three-phase symmetric suspension windings 7 are wound on the three stator suspension teeth, and are in star-shaped connection. The three stator torque teeth are axially distributed and are of inverted U-shaped structures. U-shaped opening ends of the three stator torque teeth face the rotor 9. Torque windings 6 reversely connected in series are wound on each inverted U-shaped stator torque tooth.

Both ends of the magnetic conductive bridge 1 are connected to the stator iron core 3 through the permanent magnet ring 2. The middle portion of the magnetic conductive bridge 1 is provided with a magnetism collection ring 11 which protrudes inwards and extends into the rotor 9. Six rotor teeth are uniformly distributed on an outer side of the rotor 9, i.e., a rotor tooth R₁ to a rotor tooth R₆. An outer air gap 8 is formed between the rotor tooth and the motor stator iron core 3, and an inner air gap 10 is formed between the rotor tooth and the magnetism collection ring 11.

An angle of 120° is formed among the three stator suspension teeth (i.e., the stator suspension tooth A, the stator suspension tooth B, and the stator suspension tooth C), and an axis of the stator suspension tooth A overlaps a +x-axis.

A radian of the three stator suspension teeth (i.e., the stator suspension tooth A, the stator suspension tooth B, and the stator suspension tooth C) is equal to 60°. A radian of the rotor tooth R₁ to the rotor tooth R₆ is equal to 30°. The stator torque tooth X, the stator torque tooth Y, and the stator torque tooth Z are asymmetrically distributed. A radian of each stator torque tooth is equal to 30°. An axis of the stator torque tooth X is located at 60° counterclockwise from the +x-axis. An axis of the stator torque tooth Y is located at 200° counterclockwise from the +x-axis. An axis of the torque tooth Z is located at 280° counterclockwise from the +x-axis.

When the stator suspension tooth A, the stator suspension tooth B, and the stator suspension tooth C are respectively aligned with the axes of the rotor tooth R₆, the rotor tooth R₂, and the rotor tooth R₄, the stator torque tooth X is aligned with the rotor tooth R₁, the radian of the stator torque tooth Y before the rotor tooth R₃ in the counterclockwise direction is 20°, and the radian of the stator torque tooth Z behind the rotor tooth R₅ in the counterclockwise direction is 20°.

In the embodiments, torque windings 6 reversely connected in series are wound on each inverted U-shaped stator torque tooth. Each torque winding is driven and conducted by one switching power amplifier by turns. The torque winding on the stator torque tooth Y, the torque winding on the stator torque tooth Z, and the torque winding on the stator torque tooth X are sequentially powered on during counterclockwise rotation. The torque winding on the stator torque tooth Z, the torque winding on the stator torque tooth Y, and the torque winding on the stator torque tooth X are sequentially powered on during clockwise rotation. When each torque winding is powered on, the rotor 9 rotates by 20°.

In the embodiments, the magnetism collection ring 11, the rotor 9, and the motor stator iron core 3 are designed to be sheet-shaped.

The motor stator iron core 3 and the rotor 9 are formed by laminating silicon steel steels, and the magnetism collection ring 11 and the magnetic conductive bridge 1 are made of a whole magnetic conductive material.

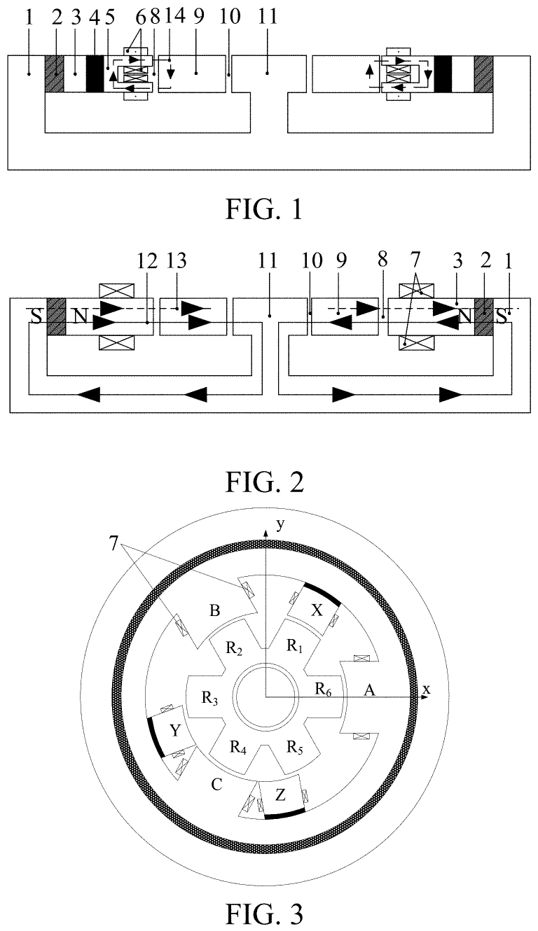

A permanent magnet ring 2 provides a static bias magnetic flux 12. As shown in FIG. 2, a magnetic circuit of the static bias magnetic flux 12 is: starting from an N-pole of the permanent magnet ring 2, the magnetic flux passes through the motor stator iron core 3, a stator suspension tooth A, a stator suspension tooth B, a stator suspension tooth C, an outer air gap 8, the rotor 9, an inner air gap 10, and the magnetism collection ring 11, and then returns to an S-pole of the permanent magnet ring 2.

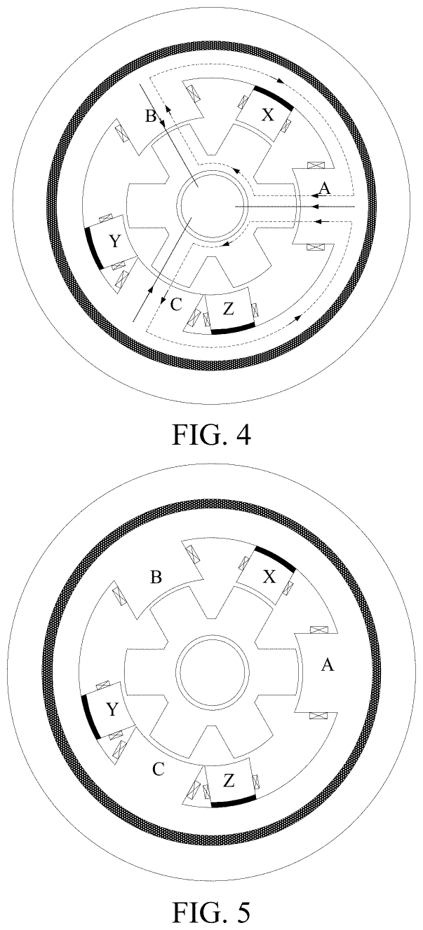

Power is supplied by a three-phase inverter to three-phase symmetric suspension windings 7 to generate a suspension control magnetic flux 13. As shown in FIG. 4, a magnetic circuit of the suspension control magnetic flux 13 is: the stator suspension tooth A, the stator suspension tooth B, the stator suspension tooth C, the outer air gap 8, rotor teeth below the stator suspension teeth, and a yoke portion of the motor stator iron core 3, to form a closed path.

The suspension principle is: the suspension principle in the axial and inclined directions is the same as that of an ordinary sheet motor, and the static bias magnetic flux 12 interacts with the suspension control magnetic flux 13 in a radial direction, so that the superposition of magnetic fields of an air gap on the same side as an eccentric direction of the rotor is weakened, while the superposition of magnetic fields of an air gap in the opposite direction is enhanced, creating a force on the rotor opposite to the rotor displacement direction, and pulling the rotor back to a radial equilibrium position.

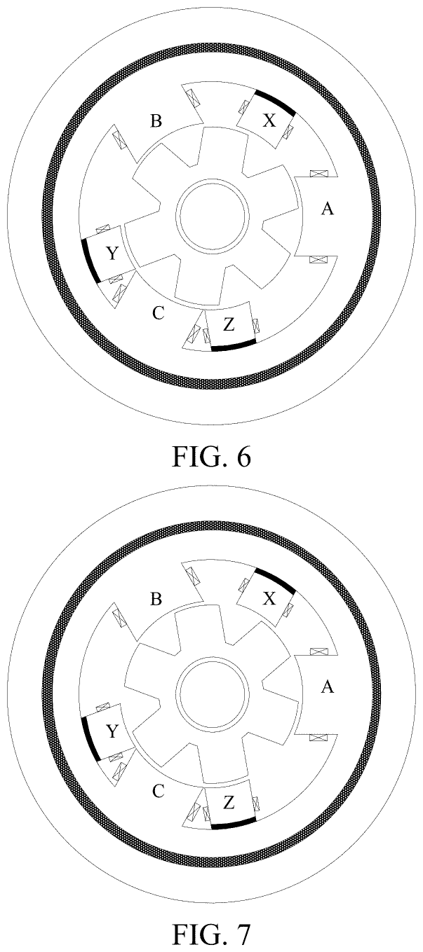

The rotation principle is: as shown in FIG. 5 to FIG. 7, when the rotor is in the state shown in FIG. 5, a winding on a stator torque tooth Y is powered on, and a torque magnetic flux 14 having a closed loop path is formed among the stator torque tooth Y, an air gap below the stator torque tooth Y, and a rotor tooth below the stator torque tooth Y, the torque magnetic flux 14 being depicted in FIG. 1; the stator torque tooth Y is 20° before a corresponding rotor tooth in the counterclockwise direction, and the magnetic flux is closed to generate a magnetic resistance, so that the rotor rotates by 20° counterclockwise, and the stator torque tooth Y is aligned with the rotor tooth, as shown in FIG. 6; moreover, in this case, a stator torque tooth Z is 20° before a corresponding torque tooth in the counterclockwise direction, and then a winding on the stator torque tooth Z is powered on, so that the rotor continues rotating by 20°, and the stator torque tooth Z is aligned with a corresponding rotor tooth, as shown in FIG. 7; in this case, a stator torque tooth X is 20° before a corresponding rotor tooth in the counterclockwise direction, and then a winding on the stator torque tooth X is powered on, so that the rotor continues rotating by 20° to form a power-on cycle, and the rotor rotates continuously and generates a continuous electromagnetic torque, without a torque dead zone.

The permanent magnet ring 2 is made of a rare-earth permanent magnet or a ferrite permanent magnet having good magnetic properties. The torque windings 6 and the suspension windings 7 are formed by winding electromagnetic coils having good conductivity, and then performing dip coating on same, and drying same.

The foregoing embodiments are only intended to illustrate the technical concept and features of the present invention, and the purpose is to enable those who are familiar with the art to understand the contents of the present invention and implement same accordingly, and cannot limit the scope of protection of the present invention. Equivalent variations or modifications made in accordance with the spirit or essence of the present invention fall within the scope of protection of the present invention.

1. A three-suspension pole magnetic suspension sheet switched reluctance motor, comprising a stator and a rotor located in the stator, wherein the stator comprises a motor stator iron core, a magnetic conductive bridge, and a permanent magnet ring; a stator suspension tooth A, a stator suspension tooth B, a stator suspension tooth C, a stator torque tooth X, a stator torque tooth Y, and a stator torque tooth Z are distributed at intervals on an inner periphery of the motor stator iron core; the three stator suspension teeth and the three stator torque teeth are arranged at intervals; the stator torque tooth X, the stator torque tooth Y, and the stator torque tooth Z are respectively connected to the motor stator iron core through a magnetism isolation aluminum block; three-phase symmetric suspension windings are wound on the three stator suspension teeth, and are in star-shaped connection; the three stator torque teeth are axially distributed and are of inverted U-shaped structures; U-shaped opening ends of the three stator torque teeth face the rotor; both ends of the magnetic conductive bridge are connected to the motor stator iron core through the permanent magnet ring; the middle portion of the magnetic conductive bridge is provided with a magnetism collection ring which protrudes inwards and extends into the rotor; and six rotor teeth are uniformly distributed on an outer side of the rotor, i.e., a rotor tooth R₁ to a rotor tooth R₆.

2. The three-suspension pole magnetic suspension sheet switched reluctance motor according to claim 1, wherein an outer air gap is formed between the rotor tooth and the motor stator iron core, and an inner air gap is formed between the rotor tooth and the magnetism collection ring.

3. The three-suspension pole magnetic suspension sheet switched reluctance motor according to claim 1, wherein an angle of 120° is formed among the three stator suspension teeth, and an axis of the stator suspension tooth A overlaps a +x-axis.

4. The three-suspension pole magnetic suspension sheet switched reluctance motor according to claim 3, wherein a radian of the three stator suspension teeth is equal to 60°, a radian of the rotor tooth R₁ to the rotor tooth R₆ is equal to 30°; the stator torque tooth X, the stator torque tooth Y, and the stator torque tooth Z are asymmetrically distributed; and a radian of each stator torque tooth is equal to 30°.

5. The three-suspension pole magnetic suspension sheet switched reluctance motor according to claim 4, wherein an axis of the stator torque tooth X is located at 60° counterclockwise from the +x-axis, an axis of the stator torque tooth Y is located at 200° counterclockwise from the +x-axis, and an axis of the stator torque tooth Z is located at 280° counterclockwise from the +x-axis.

6. The three-suspension pole magnetic suspension sheet switched reluctance motor according to claim 5, wherein when the stator suspension tooth A, the stator suspension tooth B, and the stator suspension tooth C are respectively aligned with the axes of the rotor tooth R₆, the rotor tooth R₂, and the rotor tooth R₄, the stator torque tooth X is aligned with the rotor tooth R₁, the radian of the stator torque tooth Y before the rotor tooth R₃ in the counterclockwise direction is 20°, and the radian of the stator torque tooth Z behind the rotor tooth R₅ in the counterclockwise direction is 20°.

7. The three-suspension pole magnetic suspension sheet switched reluctance motor according to claim 1, wherein torque windings reversely connected in series are wound on each inverted U-shaped stator torque tooth; each torque winding is driven and conducted by one switching power amplifier by turns; the torque winding on the stator torque tooth Y, the torque winding on the stator torque tooth Z, and the torque winding on the stator torque tooth X are sequentially powered on during counterclockwise rotation; the torque winding on the stator torque tooth Z, the torque winding on the stator torque tooth Y, and the torque winding on the stator torque tooth X are sequentially powered on during clockwise rotation; and when each torque winding is powered on, the rotor rotates by 20°.

8. The three-suspension pole magnetic suspension sheet switched reluctance motor according to claim 1, wherein the magnetism collection ring, the rotor, and the motor stator iron core are designed to be sheet-shaped.

9. The three-suspension pole magnetic suspension sheet switched reluctance motor according to claim 1, wherein the motor stator iron core and the rotor are formed by laminating silicon steel steels, and the magnetism collection ring and the magnetic conductive bridge are made of a whole magnetic conductive material.
